(19) United States
(12) Patent Application Publication
(10) Pub. No.: US 2026/0206772 A1
(43) Pub. Date: Jul. 23, 2026

(54) FULLY COOKED THAW-AND-EAT FILLED FOOD PRODUCT

(71) Applicant: General Mills, Inc., Minneapolis, MN (US)

(72) Inventors: Steven Cak, Minneapolis, MN (US); Roger G. Fuentes, St. Louis Park, MN (US); Dean V. Holt, Brooklyn Park, MN (US); Kenneth Eugene Smith, North Oaks, MN (US); Carol Uy, New Brighton, MN (US); Bernadette Zwak, Maple Grove, MN (US)

(73) Assignee: General Mills, Inc., Minneapolis, MN (US)

(21) Appl. No.: 19/455,936

(22) Filed: Jan. 22, 2026

Related U.S. Application Data
(60) Provisional application No. 63/748,760, filed on Jan. 23, 2025.

(51) Int. Cl. A21D 13/064; A21D 13/31; A21D 15/02; A23B 45/10

(52) U.S. Cl. CPC A21D 13/064; A21D 13/31; A21D 15/02; A23B 45/10

(57) ABSTRACT

The present disclosure relates to frozen, thaw-and-eat food products including a bread component at least partially enclosing a filling component, and methods of making such food products. Food products can have a total protein content of about 14% to about 25% by weight of the food product, with a bread component contributing protein in an amount of at least 10% by weight of the food product. A bread component contributes protein to a food product from included grain ingredient, gluten protein ingredient, and milk protein ingredient. A filling component includes bake stable ingredients that provide a desired flavor, texture, and nutritional value when cooked.

### CROSS-REFERENCE TO RELATED APPLICATIONS

This application claims priority to U.S. Provisional Application No. 63/748,760, filed Jan. 23, 2025, the contents of which are incorporated herein by reference in its entirety.

### TECHNICAL FIELD

The present disclosure generally relates to fully cooked food product, including a bread component and a filling component, that can be safely thawed and eaten without requiring further preparation, and methods of making such a product.

### BACKGROUND

Consumers are increasingly looking for ways to fulfill dietary needs with foods that provide enjoyable eating experiences. However, maintaining a healthy diet while on-the-go is often hindered by lack of access to nutritious food options, time constraints for preparing nutritious meals, and lack of access to cooking facilities. Thus, there is a need for convenient, healthy, and portable foods.

### SUMMARY

A frozen, fully cooked food product having a total protein content of about 14% to about 25% by weight of the food product is provided herein. A food product includes a bread component and a filling component, where the bread component has a protein content of about 20% to about 28% by weight of the bread component, the bread component contributes protein in an amount of at least 10% by weight of the food product. The bread product includes a grain ingredient, including whole grain; a gluten protein ingredient contributing about 4% to about 6% protein by weight of the bread component; and a milk protein ingredient contributing about 8% to about 15% protein by weight of the bread component. The filling component is at least partially enclosed by the bread component, where the filling component is included in an amount of about 35% to about 60% by weight of the food product. The filling component includes a continuous phase component in an amount of at least 40% by weight of the filling component.

In some embodiments, the total protein content of a food product provided herein can include at least 20% high quality protein by weight of the total protein content. In some embodiments, the milk protein ingredient can include an at least partially hydrolyzed milk protein concentrate and/or isolate and/or a sodium caseinate. In some embodiments, a bread component can include at least partially hydrolyzed milk protein concentrate and/or isolate and sodium caseinate at a ratio of about 2:1 to about 1:2.

In some embodiments, a whole grain flour can be included in a food product provided herein in an amount greater than any other ingredient in the food product. In some embodiments, a grain ingredient can contribute about 3% to about 7% fiber by weight of the bread component.

In some embodiments, a continuous phase component comprises ricotta cheese, hummus, or avocado. In some embodiments, a filling component can include discontinuous food pieces in an amount of up to 60% by weight of the filling component, the discontinuous food pieces being distributed within a continuous phase component. In some embodiments, a filling can contribute protein in an amount of at least 2% protein by weight of the food product. In some embodiments, a filling can include a fiber ingredient, such as inulin and/or soluble corn fiber. In some embodiments, a filling component can have a water activity (Aw) of at least 0.95.

In some embodiments, a food product provided herein can have a shelf life at 0° C. of at least 90 days. In some embodiments, a food product can be ready to eat when thawed at room temperature and safe to eat for at least 10 hours when held at room temperature without additional cooking.

A method of manufacturing a fully cooked food product is also provided herein. A method includes a bread dough, providing a filling component, at least partially enclosing a portion of the filling component within the bread dough to produce an uncooked food piece, and cooking the uncooked food piece for a time and temperature sufficient to produce the fully cooked food product. The bread dough can include a grain ingredient, preferably including whole grain, in an amount of about 40% to about 50% by weight of the bread dough; a gluten protein ingredient in an amount of about 4% to about 6% by weight of the bread dough; a milk protein ingredient in an amount of about 8% to about 15% by weight of the bread dough; and a moisture content of about 35% to about 40% by weight of the bread dough. A filling component can include a continuous phase component in an amount of at least 40% by weight of the filling component. The uncooked food piece can include a filling component in an amount of about 30% to about 50% by weight. A fully cooked food product can include a cooked bread component contributing protein in an amount of at least 10% by weight of the food product and having a protein content of about 20% to about 28% by weight of the bread component, the gluten protein ingredient contributing about 4% to about 6% protein by weight of the bread component, and the milk protein ingredient contributing about 8% to about 15% protein by weight of the bread component. A fully cooked food product can include a cooked filling component at least partially enclosed in the cooked bread component, the cooked filling component comprising about 35% to about 60% by weight of the food product. A fully cooked food product can include a total protein content of about 14% to about 25% by weight of the food product.

In some embodiments, a method of manufacturing a fully cooked food product can include making the bread dough by combining ingredients comprising a grain ingredient, a gluten protein ingredient, and water to form a form a first stage dough, and mixing the first stage dough with a milk protein ingredient to form the bread dough.

In some embodiments, a method of manufacturing a fully cooked food product can include a step of freezing the fully cooked food product.

In some embodiments, cooking an uncooked food piece can include baking the uncooked food piece.

In some embodiments, a filling component can have a water activity (Aw) of at least 0.95.

These and various other features and advantages will be apparent from a reading of the following detailed description.

### DETAILED DESCRIPTION

Consumers continually expect an even greater variety of high protein foods that are suitable for different eating occasions. In addition, consumers frequently look for high quality protein, rather than just total protein. However, high protein foods are often associated with a poor eating experience, such as bitter taste, astringency, and/or poor texture. Thus, developing a food product that meets nutritional expectations, yet delivers an enjoyable eating experience, can be difficult to achieve, especially in a product that has requires little to no preparation by the consumer prior to consumption.

It was discovered, and is disclosed herein, that a fully cooked thaw-and-eat filled food product can be made to include high protein while delivering a convenient and enjoyable eating experience. A food product provided herein is fully cooked and frozen, and can be thawed for consumption by removing from a freezer and allowing to thaw (e.g., at room temperature, or about 72° F.±5° F.) or heated (e.g., in a microwave) to a desired temperature. Beneficially, a food product provided herein can be removed from a freezer and held at room temperature for at least 10 hours without further cooking, allowing it to thaw, and remain safe to eat. Thus, a consumer need not be required to eat the product for several hours once the product is thawed, or need a refrigerator or cooler to keep it cold. The product described herein also provides flexibility if a consumer prefers to heat the product from frozen, or once thawed to achieve a desired temperature. A food product provided herein preferably has a shelf life at 0° C. of at least 90 days (e.g., at least 100 days).

A food product provided herein includes a bread component at least partially (e.g., fully) enclosing a filling component. Such a food product can resemble, for example, a pocket sandwich, a calzone, or the like. Although products that visually resemble a food product described herein are available on the market, most of such commercially available products do not exceed 15% total protein by weight. In contrast, a food product provided herein can have a total protein content of about 15% to about 25% (e.g., about 15% to about 20%, or about 15% to about 18%) by weight of the food product. Although there are currently available products that can be thawed and eaten more than 4 hours after thawing, such products are limited to nut butter-based fillings and total protein contents that do not exceed 12% by weight of such foods. Yet other products achieve a relatively high protein content (up to 16% by weight of the products), but require consumption within 4 hours of removing from the freezer if held at room temperature, or must be kept on an ice pack and eaten within 7 hours of removing from the freezer. This limits the window for safe consumption, and limits convenience.

Such a food product includes a bread component that contributes protein in an amount of at least 10% by weight of the food product. To achieve such a high contribution of protein to a food product, a bread component described herein has a protein content of about 20% to about 28% (e.g., about 21% to about 26%, or about 22% to about 26%) by weight of the bread component. Advantageously, such a bread component provides flexibility for combining with a variety of different fillings while still delivering a significant amount of protein. As such, although a filling for a food product provided herein can, in some embodiments, include relatively high protein content, a bread with a high protein content enables fillings to be formulated for bake stability rather than requiring high protein content in a filling.

A bread component provided herein includes a grain ingredient (e.g., flour, meal, or the like). A grain ingredient is derived from a cereal grain (e.g., wheat, oat, rye, corn, or the like) and generally contributes structure and protein to a bread component. In some embodiments, a grain ingredient contributes fiber to a bread component, e.g., in an amount of about 3% to about 7% (e.g., about 4% to about 6%) by weight of the bread component. Preferably, a grain ingredient includes whole grain, such as whole grain wheat flour, whole grain oat flour, whole grain corn meal, or the like, or any combination thereof. In some embodiments, a grain ingredient includes 100% whole grain. In some embodiments, a grain ingredient can include a blend of whole grain flour and refined grain flour (e.g, at a ratio of about 3:1 to about 1:1, or about 2:1 whole grain to refined grain). Although it was found that a bread component provided herein can be formulated with a grain ingredient that is 100% whole grain without significant bitterness or dry texture, it was found that a blend of whole grain and refined grain can further reduce perception of bitterness and/or dryness. In some embodiments, whole grain flour (e.g., whole grain wheat flour) can be included in a food product in an amount that is greater than each other ingredient included in the food product.

Although a bread component provided herein is formulated to include protein at levels often associated with poor eating experience, the described bread component achieves an enjoyable eating experience. In addition to protein contributed by a grain ingredient, a bread component can include a gluten protein ingredient. As used herein, a “gluten protein ingredient” refers to purified protein (e.g., at least 60% protein, at least 80% protein, or at least 90% protein by weight) derived from a gluten-containing cereal grain (e.g., wheat). Protein content of a gluten protein ingredient can contain non-gluten proteins that are native to a gluten-containing cereal grain, but generally the protein content of a gluten protein ingredient comprises more than 50% gluten proteins (glutenins and/or gliadins) and less than 50% non-gluten proteins. Examples of a gluten protein ingredient can include, for example, a vital wheat protein, a wheat protein concentrate, a wheat protein isolate, or the like, or any combination thereof. A gluten protein ingredient can be included in a bread component in an amount sufficient to contribute about 4% to about 6% (e.g., about 4% to about 5%) protein by weight of the bread component.

A bread component also includes a milk protein ingredient in an amount sufficient to contribute about 8% to about 15% (e.g., about 9% to about 14%, or about 10% to about 12%) protein by weight of the bread component. As used herein a “milk protein ingredient” refers to purified protein (e.g., at least 60% protein, at least 80% protein, or at least 90% protein by weight) derived from a dairy milk. Examples of a milk protein ingredient can include, for example, a milk protein concentrate or isolate, a whey protein concentrate or isolate, a calcium caseinate concentrate or isolate, a sodium caseinate concentrate or isolate, or the like, or any combination thereof. In some embodiments, a milk protein ingredient can contain protein that is at least partially hydrolyzed. For example, in some embodiments, a milk protein ingredient can comprise or consist of a partially hydrolyzed milk protein concentrate or isolate. In some embodiments, a milk protein ingredient can include a milk protein isolate (e.g., partially hydrolyzed milk protein isolate) and a sodium caseinate (e.g., at a ratio of about 3:1 to about 1:3, about 2:1 to about 1:2, or about 1:1).

In some embodiments, a milk protein ingredient can, alone or in combination with other proteins in a food product described herein, contribute to high quality protein content in the food product. In some embodiments, a food product provided herein has a total protein content that includes at least 20% (e.g., at least 22%, or about 23% to about 26%) high quality protein by weight of the total protein content. As used herein, the term “high quality protein” refers to protein content having a Protein Digestibility Corrected Amino Acid Score (PDCAAS) of 1.00. High quality protein content can be achieved by including one or more protein ingredients that each have a PDCAAS of 1.00, or by including proteins that, individually, have a PDCAAS of less than 1.00, but that complement each other to achieve a PDCAAS of 1.00. PDCAAS of protein is calculated according to the Food and Agriculture Organization of the United Nations (Joint FAO/WHO Expert Consultation (1990), Protein Quality Evaluation. Report of a Joint FAO/WO Expert Consultation held in Bethesda, MD, USA, 4-8 Dec. 1989. Food and Agriculture Organization, Rome. Section 8. ISBN 92-5-103097-9).

Other ingredients in a bread component can include sugars and/or syrups (e.g., refiner's syrup, corn syrup, and the like), fats and/or oils (e.g., canola oil, corn oil, and the like), flavorants (e.g., salt, natural and/or artificial flavors, herbs, spices, and the like), dough conditioners (e.g., DATEM, enzymes, and the like), and the like, or any combination thereof. As described below, other ingredients (e.g., leavening agents) can be included in a dough used to make a dough component, though such ingredients may not be detectable in the bread component.

A bread component provided herein surprisingly achieves not only a high protein content, but also sufficient structure to ensure that a filling component enclosed within it does not leak or make the bread component soggy during frozen storage, during thawing, or prior to eating after thawing. For example, a frozen food product provided herein was produced having a mass of about 130 g, with a bread component comprising about 55% of the mass enclosing a filling comprising about 45% of the mass. The food product was thawed to room temperature (72° F.±5° F.) and the amount of force required to cause filling to leak from the bread component was measured. Each of the tested food products could withstand at least 3 kg force before leaking.

A food product provided herein includes a cooked filling component at least partially enclosed in a bread component. A filling component is typically included in a food product in an amount of about 35% to about 60% (e.g., about 40% to about 50%) by weight of the food product. A filling component can include a continuous phase in an amount of at least 40% (e.g., at least 45%, or about 45% to 100%) by weight of the filling component. A continuous phase can include, for example, hummus, smashed avocado, or other fruit and/or vegetable-based purees, soft cheeses (e.g., ricotta, cream cheese, and the like), cheese spreads, non-dairy soft cheese and/or spread alternatives, and/or other ingredients that, when cooked, provide a desired flavor, nutritional profile, and/or texture. Although nut butters can be used in a filling component provided herein, they can increase the fat content of a food product significantly if included in large amounts, and they can cause oil-out in a filling when heated (e.g., during cooking) unless other ingredients are included to mitigate oil-out. Thus, nut butters are not preferred to be included in a filling as a major ingredient. Other ingredients suitable for inclusion in a continuous phase include ingredients that can be combined with hummus, smashed avocado, soft cheeses, and the like to form a homogenous mixture without visible particulates. For example, fruit and/or vegetable powders, protein powders, fiber ingredients (e.g., inulin, soluble corn fiber), flavorants, starches, and the like, or any combination thereof can be included in a continuous phase.

A continuous phase in a filling component can benefit manufacturing by supporting pumpability of the filling before cooking. However, rheology of an uncooked filling component can be adjusted by, for example, increasing or decreasing particulates suspended in a continuous phase, increasing or decreasing particulate size, and/or adjusting the viscosity of the continuous phase.

Discontinuous food pieces (also called particulates, herein) can optionally be included in a filling in an amount of up to 60% by weight of a filling to provide a desired flavor, nutritional profile, and/or texture. Suitable particulates can include chopped and/or diced meats (e.g., bacon, chicken, sausage, and the like), fruits and/or vegetables (e.g., peas, sun-dried tomatoes, spinach, carrot pieces, corn, diced peppers, and the like), herbs and/or seasonings (e.g., basil, oregano, parsley, pepper, and the like), cheese and/or non-dairy alternatives (e.g., cheddar, mozzarella, parmesan, and the like), seeds and/or nuts (e.g., sunflower seeds, pepitas, almonds, and the like), and the like, or any combination thereof.

In some embodiments, a filling component can have a relatively high water activity (A_{w}), e.g., at least 0.95. However, a bread component described herein can resist sogginess, and a food product provided herein remains safe to eat when thawed at room temperature for at least 10 hours, even when a filling component has relatively high water activity.

In some embodiments, one or a combination of additional protein ingredients, such as soybean protein, pea protein, canola protein, fava bean protein, or the like, can be included in a food product provided herein. An additional protein ingredient can be included in any appropriate component of a food product (e.g., bread component, filling component, or on a surface). For example, pea protein isolate and/or soy protein isolate can be included in a filling component as part of a continuous phase, or soy protein crisps can be included on a surface of a bread component for visual and/or texture impact.

In some embodiments, a food product provided herein can exclude ingredients that consumers prefer to avoid. For example, although methylcellulose can be useful in bake stability of fillings in pastries, a food product provided herein can be made without requiring the use of methylcellulose. Other examples of ingredients that, in some embodiments, can be excluded from a food product include sodium alginate, agar, and/or deli meat.

In some embodiments, nutritional attributes other than high protein content that some consumers may look for in a convenient food. For example, in some embodiments, a food product provided herein can have a total carbohydrate content of less than 35% (e.g., about 22% to about 32%) by weight. Other commercially available pocket sandwich products typically have a total carbohydrate content of at least 35% by weight. In some embodiments, a food product provided herein can have a net carbohydrate content of less than 26% (e.g., about 18% to about 25%) by weight. Other commercially available pocket sandwich products typically have a total carbohydrate content of at least 30% by weight. In some embodiments, a food product provided herein can have a fat content of less than 8% (e.g., about 3% to about 7%) by weight. Other commercially available pocket sandwich products typically have a total carbohydrate content of at least 8% by weight. In some embodiments, a food product provided herein can have a calorie content of less than 3 (e.g., about 2 to about 2.5) calories per gram weight. Other commercially available pocket sandwich products typically have a calorie content of at least 3 calories per gram weight.

Methods of making a food product provided herein can advantageously be performed on standard food manufacturing equipment. A method of making a food product includes providing a bread dough. A bread dough can include a grain ingredient in an amount of about 40% to about 50% by weight, a gluten protein ingredient in an amount of about 4% to about 6% by weight, a milk protein ingredient in an amount of about 8% to about 15% by weight. The moisture level of a dough is typically about 35% to about 40% (e.g., about 36% to about 39%) by weight. Other ingredients, as described above, can be included in a dough (e.g., in a total amount of up to 12%, or up to 10%), to provide a desired flavor, provide leavening, improve manufacturability, or the like. Preferably, a dough provided herein is leavened using yeast, but in some embodiments, a chemical leavening system can be used.

Although a dough for a bread component can be made in multiple ways, it was discovered that dough for a bread component performed best for handling using manufacturing equipment when made using two mix stages. In a first stage, ingredients including water, grain ingredient, leavening ingredient (e.g., yeast), gluten protein ingredient, and other ingredients (e.g., sugars and/or syrups, dough conditioners, oil, and the like) excluding milk protein ingredient, are mixed to form a first stage dough. In a second stage, milk protein ingredient is added to the first stage dough. This two-stage mixing can contribute to development of dough properties that help handling and forming of a dough provided herein. The two-stage process can also support inclusion of higher protein content in a dough. In embodiments, a first slow mix speed of about 33 rpm to about 38 rpm may be used, followed by a second fast mix speed of about 70 rpm to about 75 rpm.

In some embodiments, a dough for a bread component can preferably have a viscosity with a peak torque of about 1300 to about 1600 (e.g., about 1400) Brabender Units (BU). As used herein, dough viscosity is measured using a Farinograph E-Model (Brabender, Duisburg, Germany) equipped with a 300 g mixer bowl and the free evaluation procedure with a constant speed of 63 rpm. Bowl temperature is maintained at 15° C. Dough samples having a mass of 480 g are run for 10 minutes, and peak torque is recorded. Dough viscosity can be adjusted/achieved by adjusting flour content and/or water content. In some embodiments, a bread dough can have an extensibility of at least 120 (e.g., at least 130) extensograph units (EU). In further embodiments, the bread dough can have an extensibility of at least 120 EU to about 200 EU. As used herein, dough extensibility is measured using an Extensograph E-model (Brabender, Duisburg, Germany). Extensibility is measured on 150 g dough samples that are rounded and rolled to make a log. The dough log is placed in the cradle of the extensograph, crimped, and placed on the extensograph arm. After 5 minutes, the hook of the extensograph is used to stretch the dough log until it ruptures, and dough extensibility values are recorded in mm.

A dough can be proofed and formed to enclose a portion of an uncooked filling component using any appropriate method and equipment to form an uncooked food piece. For example, a dough can formed into pieces and sheeted, then folded over a portion of uncooked filling, then sealed to at least partially enclose the filling portion. In another example, a dough can be sheeted and folded over portions of uncooked filling, then the dough can be cut between portions of uncooked filling and sealed to at least partially enclose the filling portions. In another example, a dough can be sheeted into a first sheet and uncooked filling portions can be placed on top of the first sheet, and a second dough sheet can be placed on top of the filling portions, and the sheets can be cut and sealed to at least partially enclose the filling portions. In another example, a dough and uncooked filling can be coextruded and then cut or pinched into individual uncooked food pieces. In some embodiments, a dough can be sheeted to a thickness of about 2 mm to about 4 mm (e.g., about 2.8 mm to about 3.5 mm) and proofed (e.g., for about 10 minutes to about 60 minutes, about 20 minutes to about 50 minutes, or about 30 minutes to about 45 minutes) prior to being used to enclose a portion of uncooked filling.

An uncooked food piece is then cooked (e.g., baked) to fully cook the dough and filling to produce a fully cooked food product. As used herein, a “fully cooked food piece” refers to a food piece that has been heated to achieve a minimum internal temperature of at least 165° F. for at least 30 seconds, at least 175° F. for at least 6 seconds, at least 180° F. for at least 3 seconds, or at least 185° F. for at least 1 second. For example, a 130-140 g uncooked food piece can be baked at a temperature of about 325° F. to about 375° F. (e.g., about 340° F. to about 360° F.) for about 10 minutes to about 15 minutes (e.g., about 11 minutes to about 13 minutes) to produce a cooked food piece. An uncooked food piece can typically lose about 2% to about 8% (e.g., about 5%) weight during cooking due to water loss.

A cooked food piece can be frozen using any appropriate method and equipment to produce a frozen, fully cooked food product provided herein. Food product can be packaged before or after freezing in any appropriate format. For example, individual frozen fully cooked food products can be packaged in a plastic or paper pouch, and then further packaged into multi-piece packaging (e.g., 2 or 4 in a box).

It is to be understood that food pieces provided herein can be used for either sweet or savory applications in food. Food pieces disclosed herein can provide a benefit of being a high protein stand-alone food product or provide added protein in combination with other components in food products while also providing an improved texture and flavor over other known high protein pieces.

### EXAMPLES

### Example 1

Commercially available thaw-and-eat pocket sandwich products (Commercial 1-3) were assessed for nutritional information and preparation instructions and compared to exemplary food product embodiments as described herein (Formula 1-5). Table 1 shows comparisons of nutritional information for the exemplary food product embodiments of the disclosure. Table 2 shows comparisons of nutritional information for the commercially-available examples. For the comparative commercially-available examples (Commercial 1-3), the range over 4 different flavors for each was identified.

TABLE 1

| | Formula | Formula | Formula | Formula | Formula |
|---|---|---|---|---|---|
| | 1 | 2 | 3 | 4 | 5 |
| Flavor | Cali | Chicken | Caprese | Spinach | Red |
| | chicken | salad | | Pesto | pepper |
| | club | | | | hummus |
| Serving size | 130 | 130 | 130 | 130 | 130 |
| (g) | | | | | |
| Calories | 280 | 300 | 300 | 310 | 290 |
| Total fat (g) | 7 | 8 | 8 | 9 | 9 |
| Total | 32 | 35 | 38 | 36 | 36 |
| Carbohydrate | | | | | |
| (g) | | | | | |
| Dietary | 6 | 6 | 6 | 6 | 6 |
| Fiber (g) | | | | | |
| Protein (g) | 21 | 22 | 21 | 22 | 18 |
| Protein (% | 16.2% | 16.9% | 16.2% | 16.9% | 13.8% |
| wt) | | | | | |
| Carbohydrate | 24.6% | 26.9% | 29.2% | 27.7% | 27.7% |
| (% wt) | | | | | |
| Net | 20% | 22.3% | 24.6% | 23.1% | 23.1% |
| Carbohydrates | | | | | |
| (% wt) | | | | | |
| Fat (% wt) | 5.4% | 6.2% | 6.2% | 6.9% | 6.9% |
| Calories | 2.15 | 2.31 | 2.31 | 2.38 | 2.23 |
| per g | | | | | |

TABLE 2

| | Commercial 1 | Commercial 2 | Commercial 3 |
|---|---|---|---|
| Flavor | 4 flavors | 4 flavors | 4 flavors |
| Serving size (g) | 58 | 90-92 | 75 |
| Calories | 190-210 | 260-310 | 240 |
| Total fat (g) | 9 | 8-14 | 12-13 |
| Total | 23-28 | 33-35 | 27-28 |
| Carbohydrate (g) | | | |
| Dietary Fiber (g) | 2-3 | 1 | 4-5 |
| Protein (g) | 6 | 12-15 | 8-9 |
| Protein (% wt) | 10.3% | 13.3-16.3% | 10.7-12% |
| Carbohydrate | 39.7-48.3% | 35.9-38% | 36-37.3% |
| (% wt) | | | |
| Net | 34.5-44.8% | 34.8-37% | 29.3-32% |
| Carbohydrates | | | |
| (% wt) | | | |
| Fat (% wt) | 15.5% | 8.7-15.6% | 16-17.3% |
| Calories per g | 3.28-3.62 | 2.83-3.44 | 3.2 |

Preparation for the products from Table 1 included removing the product from freezer, setting on counter for 3 hours, and enjoying within 10 hours of removing from the freezer. Preparation for Commercial 1 from Table 1 included thawing at room temperature for 30-60 minutes and eating within 8-10 hours. Preparation for Commercial 2 included thawing at room temperature for 2 hours and eating within 4 hours of removing from freezer, or thawing with an ice pack for 4 hours and eating within 7 hours of removing from freezer. Preparation for Commercial 3 included removing from freezer, ready to eat in an hour, and eat within 24 hours.

### Example 2

A few exemplary food product embodiments identified in Table 1 (Formula 1, Formula 4, and Formula 5) were compared to a commercially available thaw-and-eat pocket sandwich product (Commercial 1) identified in Table 1 for a compression analysis. The analysis measured the combined effect of an intact bread crust of the sandwich products, and the viscosity/yield strength of the filling into a measure of the sandwich's resistance to having its insides leak out when being compressed. Formula 1 (Cali chicken club), Formula 4 (Spinach Pesto), and Formula 5 (Red Pepper Hummus) captured exemplary example embodiments of the current disclosure. Commercial 1 was a commercially available thaw-and-eat pocket sandwich product, as identified in Example 1. The Commercial 1 product included a filling consisting entirely of a continuous phase. Formula 1, Formula 4, and Formula 5 included varied levels of particulates in a continuous phase, with Formula 4 having the highest total concentration of particulates, Formula 1 having the second highest total concentration of particulates, and Formula 5 having the lowest total concentration of particulates. Formula 4 had about 52% continuous phase, Formula 1 had about 55% continuous phase, and Formula 5 had about 95% continuous phase. It is noted that Formula 1 had the largest individual particulate sizes compared to Formula 4 and 5 which had similar sized particulates.

To conduct the analysis, a texture analyzer instrument was equipped with a 100 kg load cell and a 4″ aluminum disc probe. The instrument was programmed to travel from a height of 40 mm at 0.5 mm/sec for a distance of 30 mm to compress the samples. All sides of the sandwiches were observed for the burst while being compressed. The precise time of the observed burst was recorded for each sample and used to find the peak force at filling yield.

The results are provided in Table 2 and show the force (kg) measured at filling yield, with further identification of the number of sandwiches tested per product type, the mean force (95% CI), minimum force, maximum force, and standard deviation.

TABLE 2

| | Number of | Peak Force (kg) | | | |
|---|---|---|---|---|---|
| | Sandwiches | | | | Standard |
| | measured (n) | Mean | Minimum | Maximum | Deviation |
| Formula 1 | 10 | 5 | 3 | 8 | 1.5 |
| (Cali chicken | | | | | |
| club) | | | | | |
| Formula 4 | 10 | 15 | 4 | 25 | 5.5 |
| (Spinach | | | | | |
| Pesto) | | | | | |
| Formula 5 | 15 | 18 | 10 | 24 | 3.5 |
| (Red Pepper | | | | | |
| Hummus) | | | | | |
| Commercial 1 | 7 | 8 | 6 | 16 | 3 |

The results indicate that the exemplary embodiment products of the disclosure are comparable to Commercial 1 or able to withstand more pressure than Commercial 1 while still maintaining filling contents within a bread component of a pocket sandwich product. This is compared to a commercial food product with lower amounts of protein, higher net carbohydrates, and higher fat content. The results show that the exemplary embodiment products of the disclosure were able to maintain heat stability and viscosity of the filling over time, while maintaining structural integrity of the bread component.

Further, it would be understood by a person having ordinary skill in the art that a product having higher amounts of particulates within the filling would have a lower peak force at filling yield compared to a product having no particulates. However, without being limited to any particular mechanism or theory, the exemplary embodiment products were able to withstand comparable or higher forces than Commercial 1 while still enclosing various food particulates within the bread component of the product.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A frozen, fully cooked food product, the food product comprising:
a. a bread component having a protein content of about 20% to about 28% by weight of the bread component, the bread component contributing protein in an amount of at least 10% by weight of the food product, the bread component including:
i. a grain ingredient, the grain ingredient comprising whole grain;
ii. a gluten protein ingredient contributing about 4% to about 6% protein by weight of the bread component; and
iii. a milk protein ingredient contributing about 8% to about 15% protein by weight of the bread component;
b. a filling component at least partially enclosed by the bread component, the filling component comprising about 35% to about 60% by weight of the food product and including a continuous phase component in an amount of at least 40% by weight of the filling component;
wherein the food product has a total protein content of about 14% to about 25% by weight of the food product.

2. The food product of claim 1, wherein the total protein content includes at least 20% high quality protein by weight of the total protein content.

3. The food product of claim 1, wherein the milk protein ingredient comprises an at least partially hydrolyzed milk protein concentrate and/or isolate.

4. The food product of claim 3, wherein the milk protein ingredient comprises a sodium caseinate.

5. The food product of claim 4, wherein the at least partially hydrolyzed milk protein concentrate and/or isolate and sodium caseinate are included at a ratio of about 2:1 to about 1:2.

6. The food product of claim 1, wherein whole grain flour is included in an amount greater than any other ingredient in the food product.

7. The food product of claim 1, wherein the grain ingredient contributes about 3% to about 7% fiber by weight of the bread component.

8. The food product of claim 1, wherein the continuous phase component comprises ricotta cheese, hummus, or avocado.

9. The food product of claim 1, wherein the filling component comprises discontinuous food pieces in an amount of up to 60% by weight of the filling component, the discontinuous food pieces being distributed within the continuous phase component.

10. The food product of claim 1, wherein the filling contributes protein in an amount of at least 2% protein by weight of the food product.

11. The food product of claim 1, wherein the filling comprises a fiber ingredient.

12. The food product of claim 11, wherein the fiber ingredient comprises inulin or soluble corn fiber.

13. The food product of claim 1, wherein the food product has a shelf life at 0 degrees C. of at least 90 days.

14. The food product of claim 1, wherein the food product is ready to eat when thawed at room temperature and safe to eat for at least 10 hours when held at room temperature without additional cooking.

15. A method of manufacturing a fully cooked food product, comprising:
a. providing a bread dough, the bread dough having:
i. a grain ingredient in an amount of about 40% to about 50% by weight of the bread dough and comprising whole grain;
ii. a gluten protein ingredient in an amount of about 4% to about 6% by weight of the bread dough;
iii. a milk protein ingredient in an amount of about 8% to about 15% by weight of the bread dough;
iv. a moisture content of about 35% to about 40% by weight of the bread dough;
b. providing a filling component, the filling component including:
i. a continuous phase component in an amount of at least 40% by weight of the filling component;
c. at least partially enclosing a portion of the filling component within a portion of the bread dough to produce an uncooked food piece, the uncooked food piece including the filling component in an amount of about 30% to about 50% by weight; and
d. cooking the uncooked food piece for a time and temperature sufficient to produce the fully cooked food product, the fully cooked food product including:
i. a cooked bread component contributing protein in an amount of at least 10% by weight of the food product and having a protein content of about 20% to about 28% by weight of the bread component, the gluten protein ingredient contributing about 4% to about 6% protein by weight of the bread component, and the milk protein ingredient contributing about 8% to about 15% protein by weight of the bread component;
ii. a cooked filling component at least partially enclosed in the cooked bread component, the cooked filling component comprising about 35% to about 60% by weight of the food product;
iii. a total protein content of about 14% to about 25% by weight of the food product.

16. The method of claim 15, comprising making the bread dough by combining ingredients comprising the grain ingredient, the gluten protein ingredient, and water to form a form a first stage dough, and mixing the first stage dough with the milk protein ingredient to form the bread dough.

17. The method of claim 15 wherein the filling component has a water activity (A_{w}) of at least 0.95.

18. The method of claim 15, comprising a step of freezing the fully cooked food product.

19. The method of claim 15, wherein cooking comprises baking.
